(19) United States
(12) Patent Application Publication
(10) Pub. No.: US 2003/0018126 A1
(43) Pub. Date: Jan. 23, 2003

(54) Method for producing impact resistant plastics

(76) Inventors: Graham Edmund McKee, Neustadt (DE); Hermann Gausepohl, Mutterstadt (DE); Norbert Niessner, Freidelsheim (DE)

Correspondence Address: KEIL & WEINKAUF, 1350 CONNECTICUT AVENUE, N.W., WASHINGTON, DC, 20036, US

(21) Appl. No.: 10/182,146

(22) PCT Filed: Jan. 26, 2001
(86) PCT No.: PCT/EP01/00897

(30) Foreign Application Priority Data
Jan. 27, 2000 (DE) 100 03 509.4

(51) Int. Cl. C08L 51/00; C08G 63/48; C08G 63/91; C08L 31/02; C08L 9/00; C08L 47/00

(52) U.S. Cl. 525/70; 525/80; 525/87

(57) ABSTRACT

The invention relates to a process for preparing an impact-modified plastic based on grafted crosslinked rubber particles, and also to an impact-modified plastic obtainable by the process. To prepare the impact-modified plastic, (a) particles of a crosslinked rubber are produced from a first monomer mixture which has a content of <50% by weight, preferably <5% by weight, particularly preferably <2% by weight, of diene compounds. The particles of the crosslinked rubber are (b) grafted with a second monomer or monomer mixture, with formation of a graft shell. Particles of the grafted crosslinked rubber are (c) added to a third monomer mixture, and the monomers of the third monomer mixture (d) are polymerized, with formation of a matrix. The process of the invention is simple to carry out and gives impact-modified plastics with very good mechanical properties, in particular with better resistance to weathering.

The invention relates to a process for preparing impact-modified plastics based on grafted crosslinked rubber particles, and also to an impact-modified plastic obtainable by the process.

Impact-modified plastics have increased resistance to mechanical effects, making them particularly suitable for many applications, e.g. for articles in everyday use. These particular properties are achieved via the structure of these plastics, which have domains of elastomers, e.g. rubbers, embedded in a matrix of a thermoplastic. The presence of two or more phases in impact-modified plastics of this type, and therefore also their domain structure, are a result of their build-up from various polymeric components which are mutually immiscible, or only partially miscible. Their impact strength is a result of increased energy uptake during deformation prior to fracture. This energy is used to form microcavities or to initiate slip processes within the matrix polymer chains. The presence of two or more phases is therefore a necessary precondition for achieving high impact strengths.

Other factors which apply are as follows:

The two chemically different polymeric components generally form a dispersion which exhibits only little phase separation during processing but has no tendency to homogenize to form a macromolecular solution on exposure to relatively high temperatures.

There has to be some coupling between the elastomer particles and the matrix, i.e. the phase boundaries have to be capable of transferring forces.

The most effective coupling at the peripheries of the elastomer particles is achieved by graft copolymerization. The procedure here is generally to take a rubber and then, via polymerization using a monomer mixture, to graft a copolymer onto this. The copolymer anchors the rubber particles in their surrounding matrix.

U.S. Pat. No 3,957,912 describes a process for preparing an acrylonitrile-butadiene-styrene polymer. Here, an alkyldiene rubber is first polymerized by emulsion polymerization with styrene monomers and/or acrylonitrile monomers, to give a grafted rubber. Styrene and/or acrylonitrile are then added to this rubber, as is at least one solvent for the styrene-acrylonitrile copolymers. The rubber is introduced into the solvent, the water is removed, and the mixture of rubber, solvent and monomer is polymerized. The introduction of the rubber into the solvent makes this process complicated to carry out. The high content of diene compounds in the rubber means that when exposed to light or other external effects, such as heat, it exhibits aging phenomena which can lead to premature wear of the workpieces.

U.S. Pat Nos. 3,903,199 and 3,903,200 describe processes for preparing acrylonitrile-butadiene-styrene polymers. Here, particles of a first grafted rubber are dispersed in a mixture of a monovinylidene aromatic monomer and an alkene nitrile monomer. This mixture may first be partially polymerized, followed by addition of particles of a second grafted rubber and completion of polymerization of the matrix, or the particles of the second grafted rubber may be added directly to the mixture of the monomers, and polymerization of the matrix completed. In both cases the plastic obtained has bimodal size distribution of the rubber particles. Each of the two processes uses rubbers which are soluble in the monomer mixtures of the matrix. Here again, the rubbers used have a high diene content, leading to the abovementioned relatively poor resistance to weathering. Plastics of this type therefore have only modest suitability for outdoor applications.

DE-A 24 00 659 describes a process for preparing impact-modified plastics by uniformly dispersing particles of alkadiene rubber, grafted with monovinylidene aromatic monomers and with alkene nitrile monomers, in a copolymer base composition made from monovinylidene aromatic monomers and from alkene nitrile monomers. The components are mixed at 120-180° C. in the presence of an organic solvent and 0-15% of water.

The particular properties of impact-modified plastics, and their broad scope of application, and their resultant commercial importance, mean that there is a constant demand for novel and improved plastic of this type.

It is an object of the present invention, therefore, to provide a process for preparing impact-modified plastics, and also an impact-modified plastic obtainable by this process.

We have found that this object is achieved by means of a process for preparing impact-modified plastic based on grafted crosslinked rubber particles, where

(a) particles of a crosslinked rubber made from a first monomer mixture are produced and have a content of <50% by weight, preferably <5% by weight, particularly preferably <2% by weight, of diene compounds,

(b) the particles of the crosslinked rubber are grafted with a second monomer or monomer mixture, with formation of a graft shell,

(c) the particles of the grafted crosslinked rubber are added to a third monomer mixture, and

(d) the monomers of the third monomer mixture are polymerized with formation of a matrix.

One reason for the simplicity of carrying out the process is the absence of any requirement for removing the aqueous phase in cases where the rubber particles are prepared by emulsion polymerization. The properties of the impact-modified plastic can be modified over a wide range, since the graft shell is formed in a separate reaction. The impact-modified plastics obtained have very high energy uptake potential, due to very strong bonding between the rubber particles and their surrounding matrix. The graft shell can achieve better compatibility, and therefore also better bonding, between rubber particles and surrounding matrix, the result also being an improvement in mechanical properties, i.e. energy uptake prior to fracture. The low content of diene compounds in the first monomer mixture improves the aging resistance of the rubber particles, and therefore also of the impact-modified plastic. To ensure that the rubber particles have sufficient elasticity, it is preferable for their glass transition temperature Tg to be <0° C., preferably <−10° C., particularly preferably <−20° C. The first step (a) of the process produces a particulate rubber onto which the second step (b) then grafts the second monomers or the second monomer mixture. This allows effective coupling of the phases to be achieved at the interfaces between the elastomer particles and the polymer matrix produced in the third step (c) from a third monomer mixture. There is no requirement for the dispersion of the grafted crosslinked rubber particles to be stable. In many instances the swelling of the grafted rubber particles in the third monomer mixture leads to gelling. During polymerization of the third monomer mixture in step (d), phase separation occurs, and the product is therefore flowable.

Examples of monomers suitable for preparing the rubber are esters of (meth)acrylic acid with C₁-C₃₀ alcohols, in particular n-butyl acrylate and ethylhexyl acrylate, isoprene, 2-chloro-1,3-butadiene, and 1-chloro-1,3-butadiene, and also other substituted butadienes and isoprenes. Examples of ways of preparing the rubber dispersion are emulsion, miniemulsion and microsuspension procedures. The graft shell is likewise preferably formed in dispersion. The processes are known per se to the skilled worker.

There are various ways of adding the dispersion of the grafted rubber particles to the third monomer mixture in step (c). The grafted rubber may be added directly as an aqueous dispersion, but it is also possible to remove the water and for the water content of the rubber particles to be <5% by weight when they are added to the third monomer mixture. It is also possible for the rubber particles first to be coagulated and then, after partial removal of the water, to have a water content from 5 to 60% by weight when added to the third monomer mixture. Examples of ways of removing the water from the grafted rubber particles are pressure filtration, centrifuging or drawing off the water at subatmospheric pressure.

An example of a suitable method is removal of the water by distillation during the polymerization of the third monomer mixture. Agglomeration or coagulation of the grafted rubber particles is, of course, also possible after addition of the aqueous dispersion to the third monomer mixture. It is advantageous for the mixture made from the third monomer mixture with grafted rubber particles, which are in the form of a dispersion if appropriate, to be homogenized by vigorous motion. One way of achieving this is to use a rotor-stator system where the rotor rotates at high speed, i.e. above 500 rpm. It is advantageous to add a protective colloid to stabilize the dispersion made from the rubber particles and from the monomers of the third monomer mixture in water. Another way of adding the grafted rubber particles to the third monomer mixture is to begin by taking only a portion of the third monomer mixture, then adding the dispersion of the grafted rubber particles and removing the water, and then adding the remainder of the third monomer mixture. This is particularly advantageous if the third monomer mixture comprises monomers readily removed with the water. In this case, the process begins by taking the lower-volatility monomers of the third monomer mixture, adding the aqueous dispersion of the grafted rubber particles and drawing off the water, followed by addition of the higher-volatility monomers of the third monomer mixture prior to polymerization of the third monomer mixture by adding a free-radical initiator. The grafted rubber particles may be swollen in the third monomer mixture for a certain time, preferably more than 5 minutes, before the polymerization of the third monomer mixture in step (d) is initiated. The polymerization of the third monomer mixture may be carried out in a single reaction, solvent or monomers remaining then being removed by introducing nitrogen gas. However, it may be technically more advantageous for the process if the polymerization of the third monomer mixture is carried out in a cascade of vessels or towers. This may be advisable if, for example, there is an excessively sharp rise in the viscosity of the reaction mixture. The polymerization of the third monomer mixture may then, for example, begin in bulk and be continued at a later juncture in suspension, after addition of water. In one advantageous embodiment, the reaction mixture is converted into a suspension at a juncture when no more than 15% of the monomers of the third monomer mixture have been polymerized.

The ratio by weight of graft shell to crosslinked rubber particle in the grafted crosslinked rubber particles is advantageously from 5:95 to 80:20, preferably from 5:95 to 60:40, particularly from 5:95 to 40:60.

The particle size of the grafted crosslinked rubber particles is advantageously <10 μm, preferably <5 μm, particularly preferably <4 μm.

The second monomer or the second monomer mixture preferably comprises at least one monomer selected from the group consisting of styrene, acrylonitrile and methyl methacrylate.

The third monomer mixture preferably comprises at least one monomer selected from the group consisting of styrene, acrylonitrile and methyl methacrylate.

In one particular embodiment of the process, the third monomer mixture may also comprise at least one other polymer which is preferably compatible or partially compatible with the polymer obtained from the third monomer mixture. For the purposes of the present invention, compatibility means that no phase separation occurs between the at least one other polymer and the polymer obtained from the third monomer mixture. One way of producing the other polymer is partial polymerization of the third monomer mixture, then adding the dispersion of the grafted rubber particles to the partially polymerized monomer mixture, and then completing the polymerization of the third monomer mixture.

The swelling index of the grafted crosslinked rubber particles is preferably from 2 to 100, with preference from 3 to 70, particularly from 3 to 60. The swelling index is determined as follows:

The swelling index is determined here as follows. A film is cast using the dispersion of the grafted crosslinked rubber particles, and the water evaporated at 23° C. The film is then dried at 50° C. and subatmospheric pressure. About 0.5 g of the film is swollen for 24 hours in a solvent, such as tetrahydrofuran or dimethylformamide. Centrifuging is then used to separate the polymer gel from the solvent which has not been incorporated into the gel. The gel is weighed, then dried and reweighed. The swelling index (SI) is calculated from the following equation:

$$SI = \frac{\text{Weight of swollen polymer gel}}{\text{Weight of dried polymer gel}}$$

The rubber particles may have a hard core made from a copolymer whose glass transition temperature is preferably Tg >0° C., particularly preferably >10° C., in particular preferably >20° C. This hard core may be composed of polystyrene, for example.

The hard core preferably has a refractive index >1.53, preferably >1.56, particularly >1.57. Impact-modified plastics which comprise small rubber particles are mostly opaque. They are therefore very difficult to color. By means of the hard core, the refractive index of the rubber particles can be matched to the surrounding polymer matrix, reducing the amount of light scattered. A hard core in which styrene or a styrene derivative is present is particularly successful in achieving this equalization. These polymers have a particularly high refractive index.

The impact-modified plastic obtained from the process of the invention can resist high mechanical stresses. It can also be used in a mixture with at least one additional plastic. Suitable additional plastics are polycarbonates, polyesters, polyamides, and polyalkyl methacrylates, where for the purposes of the invention these are either homo- or copolymers, and also high-temperature-resistant poly(ether) sulfones. Other suitable polymers are polypropylene, polyethylene, polytetrafluoroethylene (PTFE) and polystyrene-acrylonitrile. Preference is given to polyphenylene ethers (PPE), syndiotactic polystyrene, styrene-diphenylethylene copolymers, and also copolymers with a styrene content above 65% by weight. Copolymers with a styrene content above 80% by weight are preferred if the matrix-forming polymer is polystyrene or a copolymer of styrene with less than 10% by weight of the comonomer. Polycarbonates, polyesters, styrene-acrylonitrile copolymers and styrene-acrylonitrile-methyl methacrylate copolymers are particularly preferred if the matrix-forming polymer is a polystyrene-acrylonitrile copolymer or a styrene-acrylonitrile-methyl methacrylate copolymer.

We claim:

1. A process for preparing an impact-modified rubber based on grafted crosslinked rubber particles, where
(a) particles of a crosslinked rubber made from a first monomer mixture are produced and have a content of <50% by weight of diene compounds,
(b) the particles of the crosslinked rubber are grafted with a second monomer or monomer mixture, with formation of a graft shell,
(c) the particles of the grafted crosslinked rubber are added to a third monomer mixture, and
(d) the monomers of the third monomer mixture are polymerized with formation of a matrix.

2. A process as claimed in claim 1, where the ratio by weight of graft shell to the crosslinked rubber particle in the grafted crosslinked rubber particles is from 5:95 to 80:20, preferably from 5:95 to 60:40, particularly from 5:95 to 40:60.

3. A process as claimed in claim 1 or 2, where the size of the grafted crosslinked rubber particles is <10 μm, preferably <5 μm, particularly preferably <4 μm.

4. A process as claimed in any of claims 1 to 3, where the second monomer or the second monomer mixture and/or the third monomer mixture comprise or comprises at least one monomer selected from the group consisting of styrene, acrylonitrile and methyl methacrylate.

5. A process as claimed in any of claims 1 to 4, where the third monomer mixture comprises another polymer preferably compatible with the polymer formed from the third monomer mixture, and particularly built up from monomers which are the same as those of the third monomer mixture.

6. A process as claimed in any of claims 1 to 5, where the grafted crosslinked rubber particles have a swelling index of from 2 to 100, preferably from 3 to 70, particularly from 3 to 60.

7. A process as claimed in any of claims 1 to 6, where the grafted crosslinked rubber particles comprise a hard core made from a (co)polymer which has a glass transition temperature Tg >0° C., preferably >10° C., particularly preferably >20° C.

8. An impact-modified plastic based on grafted crosslinked rubber particles, obtainable by a process as claimed in any of claims 1 to 7.

9. An impact-modified plastic as claimed in claim 8, where the impact-modified plastic is present in a mixture with at least one other plastic.

10. An impact-modified plastic as claimed in claim 9, where the at least one other plastic has been selected from the group consisting of polyphenyl ether, syndiotactic polystyrene, styrene-diphenylethylene copolymers, copolymers with a styrene content >80% by weight, polycarbonates, polyesters, styrene-acrylonitrile copolymers and styrene-acrylonitrile-methyl methacrylate copolymers.
